(19) United States
(12) Patent Application Publication
(10) Pub. No.: US 2008/0149830 A1
(43) Pub. Date: Jun. 26, 2008

(54) AMELIORATING CHARGE TRAP IN INSPECTING SAMPLES USING SCANNING ELECTRON MICROSCOPE

(75) Inventors: Dong Seok BAEK, Suwon-si (KR); Chang Hoon CHOI, Seongnam-si (KR); Jeong Woo HYUN, Yongin-si (KR); Hee Soo PYUN, Suwon-si (KR); Sung Wook KANG, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/924,673

(22) Filed: Oct. 26, 2007

(30) Foreign Application Priority Data
Dec. 26, 2006 (KR) 2006-134027

(51) Int. Cl. G21K 5/00

(52) U.S. Cl. 250/310

(57) ABSTRACT

A sample inspection apparatus to inspect a sample using a scanning electron microscope irradiates the sample with electron beams. The sample inspection apparatus includes a charge collecting unit that collects charges generated from a surface of the sample due to irradiation thereof by the electron beams. The cost required for sample inspection is reduced, and an image having high quality is provided by the sample inspection apparatus.

### CROSS-REFERENCE TO RELATED APPLICATIONS

This application claims the benefit of priority under 35 U.S.C. § 119(a) of Korean Patent Application No. 2006-134027, filed on Dec. 26, 2006, in the Korean Intellectual Property Office, the disclosure of which is incorporated herein by reference in its entirety.

### BACKGROUND OF THE INVENTION

1. Field of the Invention

The present general inventive concept relates to inspecting a sample using a focused source of electrons. More particularly, the present general inventive concept relates to an apparatus and concomitant method of inspecting a sample using a scanning electron microscope in which charge trap phenomenon occurring at a sample surface is ameliorated.

2. Description of the Related Art

As semiconductor devices become more compact, the density of the pattern formed on the semiconductor substrate has increased significantly. For this reason, particles of a few micrometers or less in size may cause contamination in the manufacturing process and corresponding defects in the semiconductor devices.

Such particles may be by-products of the semiconductor manufacturing process and the materials used in the semiconductor manufacturing process. Thus, mechanisms used in the manufacturing process of semiconductor devices are generally inspected for the presence of such particles through an inspection apparatus.

FIG. 1 is a diagram of a traditional inspection apparatus to illustrate a potential barrier locally formed on a sample surface from a beam of electrons. Such potential barriers degrade the effectiveness of the inspection apparatus by distorting a path of an electron beam.

As illustrated in FIG. 1, electron beams 23 generated from an electron source (not illustrated) of a scanning electron microscope 20 are irradiated onto a surface of a sample 30 through an aperture of an objective lens 21. The objective lens 21 may include one or more focusing coils (not illustrated) to focus the electron beams 23 onto a selected region of the sample 30. Secondary particles, such as reactive ions, are emitted from the surface of the sample responsive to the electron beams 23 impinging the surface of the sample, and a distribution of the secondary particles is obtained by a detector. The distribution of secondary particles measured by the detector is generally used to form an image, such as an electron micrograph. Moreover, if the sample is a dielectric, electric charges may be trapped on the surface of the sample also responsive to the electron beams 23 impinging the surface thereof, such that a potential barrier 60 is locally formed on the surface of the sample. Such a potential barrier 60 may cause defocus and deflection of electron beams 23 and drift of the obtained image relative to the sample surface.

Therefore, an electron beam irradiation apparatus must be designed by taking such charge trap phenomenon on the sample surface into consideration. In this regard, an environmental scanning electron microscope (ESEM) has been developed to analyze and evaluate the sample.

The ESEM can analyze the sample in a nondestructive manner. In addition, the ESEM functions as both a scanning electron microscope (SEM) and an energy dispersive spectrometer. The ESEM analyzes steps and curvature formed on the surface of a sample and analyzes the composition of the sample by detecting second electrons (SEs), back scattered electrons (BSEs), and unique characteristic X-rays of a material, which are emitted from the sample surface responsive to primary electrons irradiating the sample surface.

The ESEM allows performing a common inspection process on various types of samples, but has several shortcomings.

First, the ESEM must be equipped with a differential vacuum system that creates various vacuum levels in order to collect and irradiate electron beams onto the surface of the sample.

Second, the ESEM must have a gas injector that sprays gas particles to neutralize electric charges trapped on the surface of the sample.

Third, the ESEM implements an elaborate pumping system. Since the pumping system requires an ion pump for providing an ultra high vacuum (UHV) environment in a gas chamber and a rotary pump, a diffusion pump and a turbo pump for realizing the differential vacuum system, the ESEM requires a complicated structure.

### SUMMARY OF THE INVENTION

The present general inventive concept provides an apparatus and concomitant method to inspect a sample using a focused source of electrons and ameliorating charge trap phenomenon occurring at a sample surface by incorporating a charge collection unit in the apparatus.

Additional aspects and utilities of the present general inventive concept will be set forth, in part, in the description that follows and, in part, will be apparent from the description or may be learned through practice of the general inventive concept.

The foregoing and/or other aspects and utilities of the present general inventive concept may be achieved by providing a sample inspection apparatus including a chamber to receive an inspection sample therein, a scanning electron microscope installed in the chamber so as to irradiate electron beams onto a surface of the inspection sample, and a charge collecting unit to collect charges generated from the surface of the inspection sample due to irradiation of the electron beams.

The charge collecting unit may be electrically grounded.

The charge collecting unit may be formed from a metallic material.

The metallic material of the charge collecting unit may be one of aluminum and copper.

The charge collecting unit may be spaced apart from the inspection sample by a predetermined distance and is installed between one side of the scanning electron microscope and the inspection sample.

The charge collecting unit may include a body having formed therein an aperture and a support unit branching from the body.

The sample inspection apparatus may include a fixing member to fix the support unit to an outer portion of an objective lens of the scanning electron microscope. The objective lens may be electrically grounded, the support unit may be formed with a coupling hole to install the fixing member, and the aperture of the charge collecting unit may face an aperture of the objective lens such that the electron beams pass through the aperture of the charge collecting unit.

The charge collecting unit may include a body having formed therein an aperture and a support unit extending from both sides of the body in opposition to each other and having bent structures formed thereon.

The sample inspection apparatus may further include a fixing member to fix the support unit to protrusions installed at opposite sides of the chamber. The protrusions may be electrically grounded, the support unit may be formed with a coupling hole to install the fixing member, and the aperture in the charge collecting unit may face an aperture of the objective lens such that the electron beams pass through the aperture in the charge collecting unit.

The inspection sample may include a nonconductive glass material.

The inspection sample may include a photo mask.

The foregoing and/or other aspects and utilities of the present general inventive concept may also be achieved by providing a sample inspection apparatus including a photo mask, a chamber in which to perform an inspection process of the photo mask, a scanning electron microscope to irradiate electron beams onto a surface of the photo mask; and a grounding member which is electrically grounded so as to prevent a potential barrier from being formed on a surface of the photo mask caused by charges generated from the surface of the photo mask due to irradiation by the electron beams.

The grounding member may be fixedly installed at one side of the scanning electron microscope or the chamber.

The grounding member may be installed between one side of the scanning electron microscope and the photo mask.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating a potential barrier, which is locally formed on a sample surface while disturbing a path of an electron beam;

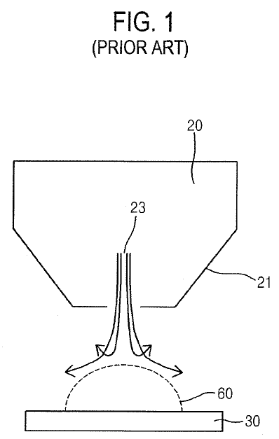

FIG. 2 is a view illustrating a structure of a sample inspection apparatus using a scanning electron microscope according to one embodiment of the present general inventive concept;

FIG. 3 is a perspective view illustrating a structure of a first grounding member according to an embodiment of the present general inventive concept;

FIG. 4 is a perspective view illustrating a structure of a second grounding member according to another embodiment of the present general inventive concept;

FIG. 5 is a view illustrating a sample inspection apparatus using a scanning electron microscope to operate according to an embodiment of the present general inventive concept;

FIG. 6 is a view illustrating an image obtained from a sample inspection apparatus without a charge collecting unit installed according to the present general inventive concept; and

FIG. 7 is a view illustrating an image obtained from a sample inspection apparatus having a charge collecting unit according to embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

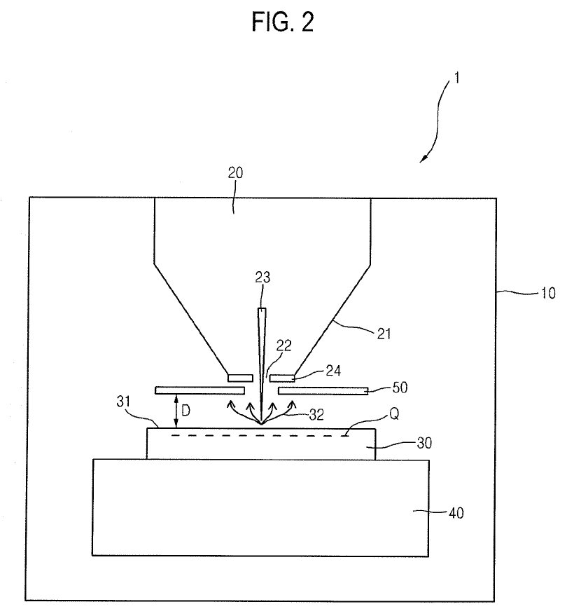

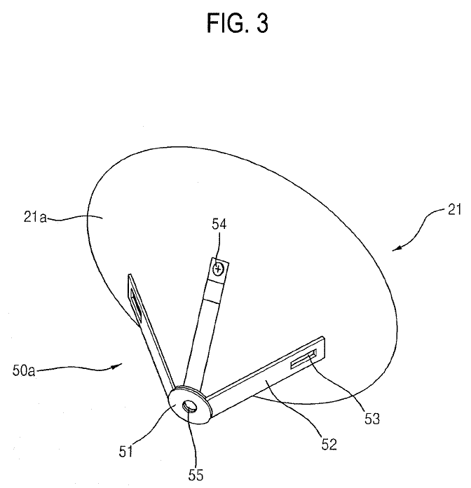

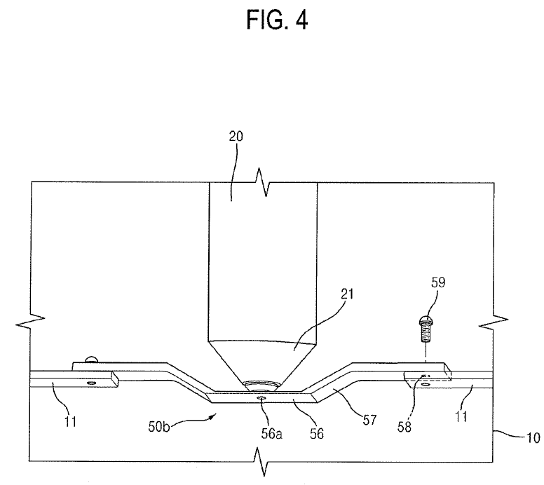

FIG. 2 illustrates a structure of a sample inspection apparatus using a scanning electron microscope according to an embodiment of the present general inventive concept, FIG. 3 is a perspective view illustrating a structure of a first grounding member according to an embodiment of the present general inventive concept, and FIG. 4 is a perspective view illustrating a structure of a second grounding member according to another embodiment of the present general inventive concept.

In certain embodiments of the present general inventive concept, a typical scanning electron microscope (SEM) is implemented to obtain images of the surface being scrutinized, instead of an expensive environmental scanning electron microscope (ESEM) having a complicated structure. As used herein, the typical SEM refers to a microscope having a focused source of electrons to inspect a sample having nonconductor characteristics, such as a photo mask. However, the sample inspection apparatus may be equipped with other charged particle sources to cause those particles to impinge the surface of the photo mask for inspection, but that consequently produce the above-identified charge trap phenomenon.

In order to ameliorate the charge trap phenomenon occurring when the exemplary SEM inspects the sample, the present general inventive concept includes a charge collecting unit that collects electric charges, which will be described below in detail.

As illustrated in FIG. 2, the exemplary sample inspection apparatus 1 according to an embodiment of the present general inventive concept includes an SEM 20 and a sample stage 40 provided in a chamber 10.

The structure of the SEM 20 illustrated in FIG. 2 is similar to that of a conventional SEM. The SEM 20 generates electron beams 23 to irradiate a sample 30 through an aperture 22 of an objective lens 21. According to this embodiment, the sample 30 includes a photo mask.

Thus, the electron beams 23 impinge the surface of the photo mask 30 retained on the sample stage 40. As the electron beams 23 are irradiated onto the photo mask 30, reactive ions 32, such as secondary electrons (SEs), back scattered electrons (BSEs), and the like are emitted from the surface of the photo mask 30 toward a detector 24. The detector 24 obtains an image of the sample surface based on the distribution of the reactive ions 32 on the detector 24.

Charges Q are trapped on the surface of the photo mask 30 as a consequence of the electron beams 23 impinging the photo mask 30. Since the photo mask 30 is formed from a dielectric material such as glass, and has formed on a surface thereof a device pattern, errors in imaging the device pattern may occur if charges are trapped on the surface of the photo mask 30 to form a potential barrier.

In detail, charges Q trapped on the surface of the photo mask 30 can be expressed by following Equation 1.

I₀=σ*I₀+dQt/dt+I_{L} (Equation 1)

Wherein, I₀ is an amount of irradiated current, σ (=η+δ) is a combination value of η and δ, in which η is a BSE rate value and δ is a yield value of SE, dQt/dt is an amount of charges trapped on the sample surface as a function of time, and I_{L} is a current that is extinguished through conversion into other energy, such as heat or light, or through electron-hole recombination.

Charges Q trapped on the surface of the photo mask 30 can be expressed by following Equation 2 based on Equation 1.

dQt/dt=(1−σ)*I₀−I_{L} (Equation 2)

As an amount of charges trapped on the sample surface increases, a potential barrier is locally formed on the surface of the photo mask 30, and the path of the electron beams are influenced by the potential barrier. Although the potential barrier is locally formed, since the SEM obtains highly-magnified images of the sample surface by using secondary electrons, the potential barrier may exert intolerable degradation of the image quality.

In this regard, the sample inspection apparatus using the exemplary SEM in accordance with embodiments of the present general inventive concept includes a charge collecting unit 50 interposed between the objective lens 21 and the photo mask 30.

The charge collecting unit 50 is spaced apart from the photo mask 30 by a working distance D, which may be on the order of a few nanometers. According to embodiments illustrated in FIGS. 2-4, the charge collecting unit 50 may be realized as first and second grounding members 50a and 50b, respectively. The first and second grounding members 50a and 50b are made from highly conductive materials, such as the metals aluminum (Al) and copper (Cu).

As illustrated in FIG. 3, the first grounding member 50a includes a thin body 51 having formed therein an aperture 55 and three support legs 52 branching from the body 51. The aperture 55 faces the aperture 22 of the objective lens 21 such that electron beams 23 pass through the aperture 55. The support legs 52 have formed thereon coupling holes 53 so that the support legs 53 can be fixedly coupled to a conical outer housing 21a of the objective lens 21. That is, fixing screws 54 are threadedly-coupled into the conical outer housing 21a of the objective lens 21 through the coupling holes 53, thereby fixing the support legs 52 to the conical outer housing 51a of the objective lens 21. The conical outer housing 51a of the objective lens 21 may be electrically grounded and, accordingly, the first grounding member 50a is electrically grounded through the fixing screws 54. The electrical grounding of the grounding member 50a may be achieved by other techniques that perform the intended purposes and the present general inventive concept is intended to encompass all such alternative implementations.

As illustrated in FIG. 4, the second grounding member 50b includes a thin body 56 having formed therein an aperture 56a and two support legs 57 extending from the body 56 in opposition to each other. The supports legs 57 may have bent extension structures to situate the grounding member 50b in the proper position at the aperture 22 of the objective lens 21. The aperture 56a faces the aperture 22 of the objective lens 21 such that the electron beams 23 can pass through the aperture 56a. The support legs 57 are formed with coupling holes 58 so that the support legs 57 can be fixedly coupled to protrusions 11 provided at opposing sides of the chamber 10. That is, fixing screws 59 are threadedly-coupled into the protrusions 11 of the chamber 10 through the coupling holes 58, thereby fixing the support legs 57 of the second grounding member 50b to the protrusions 11 of the chamber 10. The protrusions 11 provided at both sides of the chamber 10 may be electrically grounded, in which case, the second grounding member 50b is electrically grounded. As with the embodiment described above, other grounding techniques may be implemented as an alternative or an addition to the grounding previously described.

Hereinafter, the operation of the sample inspection apparatus using the exemplary SEM according to an embodiment of the present general inventive concept invention will be described with reference to accompanying drawings.

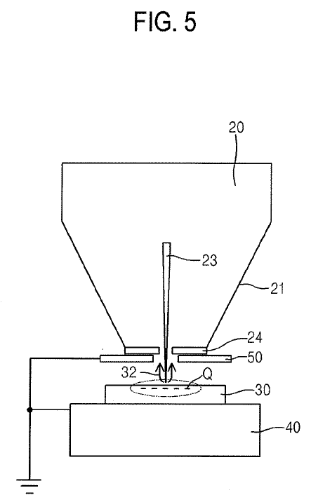

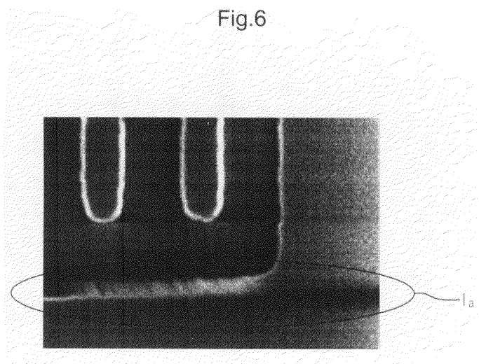

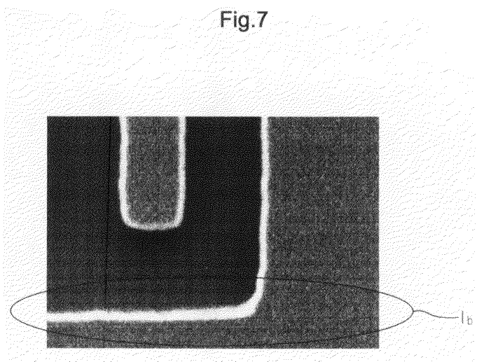

FIG. 5 illustrates certain operations to inspect a sample with the sample inspection apparatus using the SEM according to an embodiment of the present general inventive concept, FIG. 6 is an image obtained from a typical prior art sample inspection apparatus and FIG. 7 is an image obtained from a sample inspection apparatus according to an exemplary embodiment of the present general inventive concept.

Electron beams 23 are generated from the focused electron source of the SEM 20 and are irradiated onto the photo mask 30. Consequently, charges are trapped on the surface of the photo mask 30. The amount of the charges trapped on the surface of the photo mask 30 increases over time until the potential barrier is locally formed on the surface of the photo mask 30. Such a potential barrier must be removed or significantly weakened to the point where the potential barrier does not degrade the image quality. For example, as illustrated in FIG. 6, drift phenomenon occurs at a predetermined region Ia of the image obtained without applying the features and utilities of the present general inventive concept. Such drift phenomenon may render the resulting image insufficient for sample inspection work.

As illustrated in FIG. 5, the charge collecting unit 50 is electrically grounded, such as by the techniques described above with reference to first and second grounding members 50a and 50b illustrated in FIGS. 3 and 4. Therefore, the charge collecting unit 50 collects the charges which are formed on the surface of the photo mask 30 due to irradiation by the electron beams 23. Thus, charge trap phenomenon does not occur at the surface of the photo mask 30 or the charge trap phenomenon is significantly weakened through practice of the present general inventive concept. Thus, a potential barrier is prevented from being formed on the surface of the photo mask 30.

In this manner, since the charge collecting unit 50 collects the charges from the surface of the photo mask 30, the potential barrier is not formed, or rarely forms, on the surface of the photo mask 30, so that a high-quality image can be obtained. FIG. 7 illustrates an image obtained by applying the features and utilities of the present general inventive concept and exhibits a clear line at the predetermined region Ib corresponding to the predetermined region Ia illustrated in FIG. 6. The image in FIG. 7 is well-suited for sample inspection.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A sample inspection apparatus comprising:
a chamber for receiving an inspection sample therein;
a scanning electron microscope installed in the chamber to irradiate electron beams onto a surface of the inspection sample; and
a charge collecting unit to collect charges generated from the surface of the inspection sample due to irradiation of the electron beams.

2. The sample inspection apparatus as set forth in claim 1, wherein the charge collecting unit is electrically grounded.

3. The sample inspection apparatus as set forth in claim 1, wherein the charge collecting unit is formed from a metallic material.

4. The sample inspection apparatus as set forth in claim 3, wherein the metallic material is one from a group consisting of aluminum and copper.

5. The sample inspection apparatus as set forth in claim 1, wherein the charge collecting unit is spaced apart from the inspection sample by a predetermined distance and is installed between one side of the scanning electron microscope and the inspection sample.

6. The sample inspection apparatus as set forth in claim 1, wherein the charge collecting unit includes a body having formed therein an aperture and a support unit branching from the body.

7. The sample inspection apparatus as set forth in claim 6, further comprising:
a fixing member to fix the support unit to an outer portion of an objective lens of the scanning electron microscope, wherein the objective lens is electrically grounded, the support unit is formed with a coupling hole to install the fixing member, and the aperture of the charge collecting unit faces an aperture of the objective lens such that the electron beams pass through the aperture of the charge collecting unit.

8. The sample inspection apparatus as set forth in claim 1, wherein the charge collecting unit includes a body having formed therein an aperture and a support unit extending from both sides of the body in opposition to each other.

9. The sample inspection apparatus as set forth in claim 8, further comprising:
a fixing member to fix the support unit to protrusions installed on opposing sides of the chamber, wherein the protrusions are electrically grounded, the support unit is formed with a coupling hole to install the fixing member, and the aperture in the charge collecting unit faces an aperture of an objective lens such that the electron beams pass through the aperture in the charge collecting unit.

10. The sample inspection apparatus as set forth in claim 1, wherein the inspection sample includes a nonconductive glass material.

11. The sample inspection apparatus as set forth in claim 10, wherein the inspection sample includes a photo mask.

12. A sample inspection apparatus comprising:
a photo mask;
a chamber in which to perform an inspection process of the photo mask;
a scanning electron microscope to irradiate electron beams onto a surface of the photo mask; and
a grounding member which is electrically grounded to prevent a potential barrier from being formed on a surface of the photo mask caused by charges generated from the surface of the photo mask due to irradiation by the electron beams.

13. The sample inspection apparatus as set forth in claim 12, wherein the grounding member is fixedly installed at one side of the scanning electron microscope or the chamber.

14. The sample inspection apparatus as set forth in claim 12, wherein the grounding member is installed between one side of the scanning electron microscope and the photo mask.
